(19) United States
(12) Patent Application Publication
(10) Pub. No.: US 2017/0324347 A1
(43) Pub. Date: Nov. 9, 2017

(54) SOFT-SWITCHING BIDIRECTIONAL PHASE-SHIFT CONVERTER WITH EXTENDED LOAD RANGE

(71) Applicant: Hong Kong Productivity Council, Hong Kong (CN)

(72) Inventors: Wenzheng XU, Hong Kong (CN); Hon-lung CHAN, Hong Kong (CN); Ka-wing Kevin CHAN, Hong Kong (CN)

(73) Assignee: Hong Kong Productivity Council, Hong Kong (CN)

(21) Appl. No.: 15/475,152

(22) Filed: Mar. 31, 2017

(30) Foreign Application Priority Data
May 5, 2016 (CN) 201610294588.5

(51) Int. Cl. H02M 3/335; H02M 1/08; H02M 1/00

(52) U.S. Cl. CPC H02M 3/33584; H02M 1/083; H02M 2001/0058

(57) ABSTRACT

The present invention discloses a soft-switching bidirectional phase-shift converter with an extended load range, which is in particularly applicable to system for the fast charging of electric vehicles in various occasions, comprising an inverter bridge, a rectifier bridge, a transformer connected between the output side of the inverter bridge and the input side of the rectifier bridge, and an equivalent inductor representing the leakage inductance of a primary side of the transformer, wherein a DC input voltage is applied to the input side of the inverter bridge, and an output load is connected to the output side of the rectifier bridge. The phase-shift converter provided by the present invention is applicable to light-load cases, without influencing the operation in heavy-load cases, so the available load range of the present charger is extended compared to conventional phase shift converters.

### CROSS REFERENCE TO RELATED APPLICATIONS

This application is based upon and claims priority to Chinese Patent Application No. CN201610294588.5, filed on May 5, 2016, the entire contents of which are incorporated herein by reference.

### TECHNICAL FIELD

The present invention relates to a phase-shift converter based on zero-voltage switching and zero-current switching technologies, in particular to a soft-switching bidirectional phase-shift converter which is applicable to a system for quickly charging an electric vehicle in various occasions and which can realize a linear control of an output voltage and has a wider output load range.

### BACKGROUND

At present, the electric vehicle industry is developing rapidly and has a promising prospect, and related fast charging technologies are indispensable. It is crucial to develop high-performance vehicle fast-charging piles. Among various types of DC-DC converters, phase-shift converters are widely used as the basic topological structures of the chargers for electric vehicles, due to their advantages of low loss, high power density, fixed switching frequency, easy control, etc. However, due to its own limitations, the phase-shift converter topology has low output efficiency in the light load case, which influences the stability of the converter, and has no capability of linear control of output voltage.

Chinese Patent CN104333229A discloses a phase-shift full-bridge switch converter. A phase-shift full-bridge switch converter capable of improving the reliability of a power semiconductor switch device is provided in view of the defects in the prior art wherein a resonant transformer circuit and a resonant transformer controller are additionally provided between a leading bridge arm and its isolated driving circuit, and a high-frequency transformer, and an output current sampling circuit are additionally provided between the output ground terminal of an output filter circuit and a phase-shift control circuit.

However, in the researches on phase-shift converters currently done in the social and academic circles, including the above invention, the problem that the efficiency of a phase-shift converter becomes lower in light-load cases has not yet been solved, and the linear control of output voltage cannot be realized.

### SUMMARY OF THE INVENTION

In view of this, a main objective of the present invention is to provide a soft-switching bidirectional phase-shift converter which can realize a linear control of output voltage and has a wider output load range. By changing the control mode of each switching transistor, the phase-shift converter is applicable to the light-load case, without influencing the operation in heavy-load case.

To achieve this objective, the present invention discloses a soft-switching bidirectional phase-shift converter with an extended load range, including an inverter bridge, a rectifier bridge, a transformer connected between the output side of the inverter bridge and the input side of the rectifier bridge, and an equivalent inductor representing the leakage inductance of a primary side of the transformer, wherein a DC input voltage is applied to the input side of the inverter bridge, and an output load is connected to the output side of the rectifier bridge.

The inverter bridge includes a leading bridge arm for realizing zero-current switching, and a lagging bridge arm for realizing zero-voltage switching.

The leading bridge arm includes: an inverter-side MOSFET switching transistor Q1 and an antiparallel diode D1 and a stray capacitor C1 respectively corresponding to the inverter-side MOSFET switching transistor Q1, which are all connected in parallel, and an inverter-side MOSFET switching transistor Q2, and an antiparallel diode D2 and a stray capacitor C2 respectively corresponding to the inverter-side MOSFET switching transistor Q2, which are all connected in parallel; and, the lagging bridge arm includes an inverter-side MOSFET switching transistor Q3 and an antiparallel diode D3 and a stray capacitor C3 respectively corresponding to the inverter-side MOSFET switching transistor Q3 which are all connected in parallel, and an inverter-side MOSFET switching transistor Q4 and an antiparallel diode D4 and a stray capacitor C4 respectively corresponding to the inverter-side MOSFET switching transistor Q4 which are all connected in parallel.

The drain of the inverter-side MOSFET switching transistor Q1 is connected to the anode of the antiparallel diode D1 and one terminal of the stray capacitor C1, while the source thereof is connected to the cathode of the antiparallel diode D1 and the other terminal of the stray capacitor C1; the drain of the inverter-side MOSFET switching transistor Q2 is connected to the anode of the antiparallel diode D2 and one terminal of the stray capacitor C2, while the source thereof is connected to the cathode of the antiparallel diode D2 and the other terminal of the stray capacitor C2; the drain of the inverter-side MOSFET switching transistor Q1 is connected to the source of the inverter-side MOSFET switching transistor Q2.

The drain of the inverter-side MOSFET switching transistor Q3 is connected to the anode of the antiparallel diode D3 and one terminal of the stray capacitor C3, while the source thereof is connected to the cathode of the antiparallel diode D3 and the other terminal of the stray capacitor C3; the drain of the inverter-side MOSFET switching transistor Q4 is connected to the anode of the antiparallel diode D4 and one terminal of the stray capacitor C4, while the source thereof is connected to the cathode of the antiparallel diode D4 and the other terminal of the stray capacitor C4; and, the drain of the inverter-side MOSFET switching transistor Q3 is connected to the source of the inverter-side MOSFET switching transistor Q4.

The anode of the DC input voltage is connected to the sources of the inverter-side MOSFET switching transistors Q1 and Q3, while the cathode thereof is connected to the drains of the inverter-side MOSFET switching transistors Q2 and Q4.

The inverter bridge further includes an input filter capacitor which is located on the input side of the inverter bridge and connected to the DC input voltage in parallel; and, the anode of the DC input voltage is connected to the anode of the input filter capacitor, while the cathode thereof is connected to the cathode of the input filter capacitor.

The rectifier bridge includes: a rectifier-side MOSFET switching transistor M1, and an antiparallel diode Dm1 and a stray capacitor Cm1 respectively corresponding to the rectifier-side MOSFET switching transistor M1, which are all connected in parallel; a rectifier-side MOSFET switching transistor M2, and an antiparallel diode Dm2 and a stray capacitor Cm2 respectively corresponding to the rectifier-side MOSFET switching transistor M2, which are all connected in parallel; a rectifier-side MOSFET switching transistor M3, and an antiparallel diode Dm3 and a stray capacitor Cm3 respectively corresponding to the rectifier-side MOSFET switching transistor M3, which are all connected in parallel; and a rectifier-side MOSFET switching transistor M4, and an antiparallel diode Dm4 and a stray capacitor Cm4 respectively corresponding to the rectifier-side MOSFET switching transistor M4, which are all connected in parallel.

One terminal of the equivalent inductor is connected to the drain of the inverter-side MOSFET switching transistor Q1 of the leading bridge arm while the other terminal thereof is connected to one terminal of the primary side of the transformer, and the other terminal of the primary side of the transformer is connected to the drain of the inverter-side MOSFET switching transistor Q3 of the lagging bridge arm; a secondary-side dotted-terminal of a terminal of the transformer connected to the primary-side equivalent inductor is connected to the drain of the rectifier-side MOSFET switching transistor M1, and connected to the source of the rectifier-side MOSFET switching transistor M2, the anode of the antiparallel diode Dm1, the cathode of the antiparallel diode Dm2, one terminal of the stray capacitor Cm1 and one terminal of the stray capacitor Cm2; a secondary-side dotted-terminal of a terminal of the transformer not connected to the primary-side equivalent inductor is connected to the drain of the rectifier-side MOSFET switching transistor M3, and connected to the source of the rectifier-side MOSFET switching transistor M4, the anode of the antiparallel diode Dm3, the cathode of the antiparallel diode Dm4, one terminal of the stray capacitor Cm3 and one terminal of the stray capacitor Cm4; the cathode of the antiparallel diode Dm1 is connected to the cathode of the antiparallel diode Dm3, and connected to the cathode of the output load, the other terminal of the stray capacitor Cm1 and the other terminal of the stray capacitor Cm3; and, the anode of the antiparallel diode Dm2 is connected to the anode of the antiparallel diode Dm4, and connected to the cathode of the output load, the other terminal of the stray capacitor Cm2 and the other terminal of the stray capacitor Cm4.

The rectifier further includes an output filter capacitor located on the output side; the cathode of the antiparallel diode Dm1 and the cathode of the antiparallel diode Dm3 are connected to the anode of the output filter capacitor, and the anode of the output filter capacitor is connected to the anode of the output load; and, the anode of the antiparallel diode Dm2 and the anode of the antiparallel diode Dm4 are connected to the cathode of the output filter capacitor, and the cathode of the output filter capacitor is connected to the cathode of the output load.

For the phase-shift converter system for quickly charging an electric vehicle based on zero-voltage switching and zero-current switching in the present invention, by optimizing on basis of a typical topology and changing the control mode of each switching transistor, the phase-shift converter is applicable to light-load cases, without influencing the operation in heavy-load cases, so the available load range of the present charger is extended. Under the optimal control and topological conditions, the present invention can realize the linear control of output voltage of the phase-shift converter, so that it is more advantageous for the control of output characteristics of the charger.

### BRIEF DESCRIPTION OF THE DRAWINGS

FIG. 1 is a schematic diagram of a topological structure of a phase-shift converter based on the zero-voltage and zero-current switching technology according to the present invention;

FIG. 2 is a schematic diagram of control of switching ransistors in the circuit according to the present invention;

FIG. 3 is an equivalent circuit diagram of a power transfer stage according to the present invention;

FIG. 4 is a schematic diagram of DC characteristics of an improved phase-shift converter according to the present invention;

FIG. 5 is a comparison diagram of an improved output linear voltage control and a conventional output non-linear voltage control according to the present invention;

FIG. 6 is a schematic diagram of the maximum load current under the boundary zero-current switching according to the present invention;

FIG. 7 is an equivalent circuit diagram of a freewheeling stage according to the present invention;

FIG. 8 is a schematic diagram of an extended output load range according to the present invention; and

FIG. 9 is a comparison diagram of power conversion efficiency of full load range according to the present invention.

FIG. 10 is a comparison diagram of power conversion efficiency in light load case according to the present invention.

FIG. 11 is a diagram of transformer primary voltage and current of the present invention at an output power of 115 W.

FIG. 12 is a diagram of drain-source voltage, drain current and gate voltage of transistor Q2 which shows its switching under zero current condition.

FIG. 13 is a diagram of drain-source voltage, drain current and gate voltage of transistor Q4 which shows its switching under zero voltage condition.

### DETAILED DESCRIPTION OF THE INVENTION

To further understand the structure and implementation effects of the present invention, details will be described hereinafter by preferred embodiments with reference to the accompanying drawings.

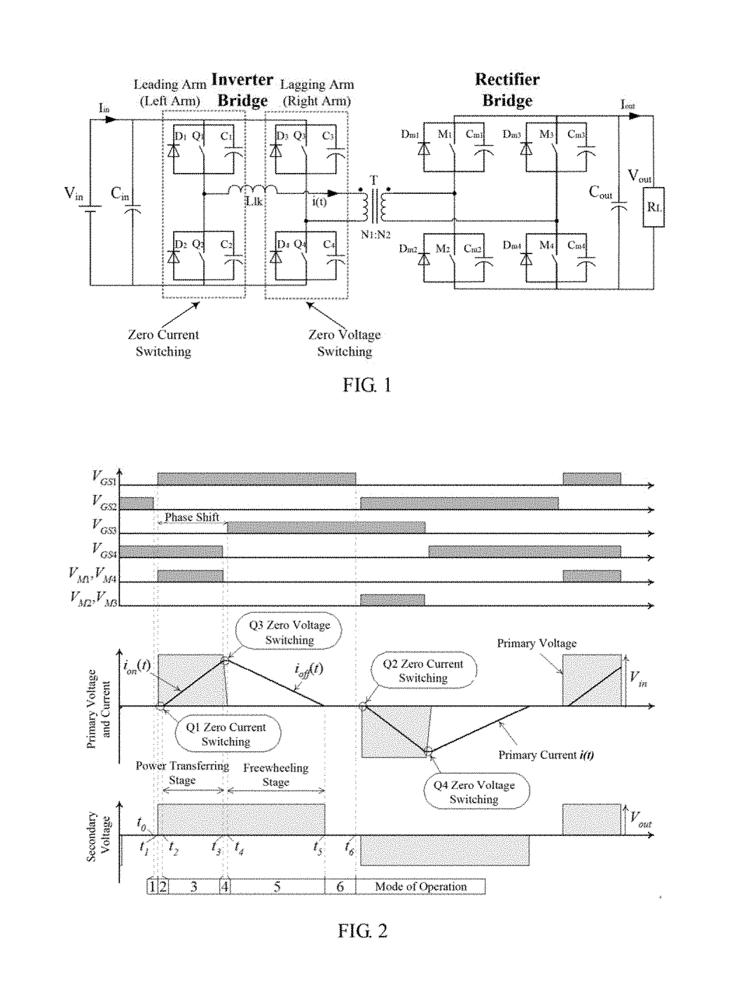

FIG. 1 is a schematic diagram of a topological structure of a phase-shift converter based on the zero-voltage and zero-current switching technology according to the present invention, which is a core component of an electric vehicle charger. As shown in FIG. 1, the topological structure provided by the present invention is based on a conventional DC-DC phase-shift converter, but on the output diode rectifier bridge side, control is changed to be performed by a switching transistor having a reverse diode. The bidirectional phase-shift converter provided by the present invention includes an inverter bridge, a rectifier bridge, a transformer T connected between the output side of the inverter bridge and the input side of the rectifier bridge, and an equivalent inductor Lₗₖ (not shown) representing the linkage inductance of a primary side of the transformer T. The ratio of transformation of the transformer T is N1:N2. A DC input voltage Vᵢₙ is applied to the input side of the inverter bridge, and an output load R_{L} is connected to the output side of the rectifier bridge.

The inverter bridge includes a leading bridge arm (i.e., left arm) for realizing zero-current switching and a lagging bridge arm (i.e., right arm) for realizing zero-voltage switching. The inverter bridge may further include an input filter capacitor Cᵢₙ which is located on the input side and connected to the DC input voltage Vᵢₙ in parallel.

The leading bridge arm includes: an inverter-side MOSFET switching transistor Q1, and an antiparallel diode D1 and a stray capacitor C1 respectively corresponding to the inverter-side MOSFET switching transistor Q1, which are all connected in parallel, and an inverter-side MOSFET switching transistor Q2, and an antiparallel diode D2 and a stray capacitor C2 respectively corresponding to the inverter-side MOSFET switching transistor Q2, which are all connected in parallel. The drain of the inverter-side MOSFET switching transistor Q1 is connected to the anode of the antiparallel diode D1 and one terminal of the stray capacitor C1, while the source thereof is connected to the cathode of the antiparallel diode D1 and the other terminal of the stray capacitor C1. The drain of the inverter-side MOSFET switching transistor Q2 is connected to the anode of the antiparallel diode D2 and one terminal of the stray capacitor C2, while the source thereof is connected to the cathode of the antiparallel diode D2 and the other terminal of the stray capacitor C2. The drain of the inverter-side MOSFET switching transistor Q1 is connected to the source of the inverter-side MOSFET switching transistor Q2. The lagging bridge arm includes: an inverter-side MOSFET switching transistor Q3 and an antiparallel diode D3 and a stray capacitor C3 respectively corresponding to the inverter-side MOSFET switching transistor Q3 which are all connected in parallel, and an inverter-side MOSFET switching transistor Q4 and an antiparallel diode D4 and a stray capacitor C4 respectively corresponding to the inverter-side MOSFET switching transistor Q4 which are all connected in parallel. The drain of the inverter-side MOSFET switching transistor Q3 is connected to the anode of the antiparallel diode D3 and one terminal of the stray capacitor C3, while the source thereof is connected to the cathode of the antiparallel diode D3 and the other terminal of the stray capacitor C3. The drain of the inverter-side MOSFET switching transistor Q4 is connected to the anode of the antiparallel diode D4 and one terminal of the stray capacitor C4, while the source thereof is connected to the cathode of the antiparallel diode D4 and the other terminal of the stray capacitor C4, The drain of the inverter-side MOSFET switching transistor Q3 is connected to the source of the inverter-side MOSFET switching transistor Q4.

The anode of the DC input voltage Vᵢₙ is connected to the anode of the input filter capacitor Cᵢₙ and also connected to the sources of the inverter-side MOSFET switching transistors Q1 and Q3, while the cathode thereof is connected to the cathode of the input filter capacitor Cᵢₙ and also connected to the drains of the inverter-side MOSFET switching transistors Q2 and Q4.

The rectifier bridge in the present invention includes: a rectifier-side MOSFET switching transistor M1, and an antiparallel diode Dm1 and a stray capacitor Cm1 respectively corresponding to the rectifier-side MOSFET switching transistor M1, which are all connected in parallel; a rectifier-side MOSFET switching transistor M2, and an antiparallel diode Dm2 and a stray capacitor Cm2 respectively corresponding to the rectifier-side MOSFET switching transistor M2, which are all connected in parallel; a rectifier-side MOSFET switching transistor M3, and an antiparallel diode Dm3 and a stray capacitor Cm3 respectively corresponding to the rectifier-side MOSFET switching transistor M3, which are all connected in parallel; and a rectifier-side MOSFET switching transistor M4, and an antiparallel diode Dm4 and a stray capacitor Cm4 respectively corresponding to the rectifier-side MOSFET switching transistor M4, which are all connected in parallel. The rectifier may further include an output filter capacitor Cₒᵤₜ which is located on the output side and connected to the output load R_{L} in parallel.

One terminal of the equivalent inductor Lₗₖ is connected to the drain of the inverter-side MOSFET switching transistor Q1 of the left arm while the other terminal thereof is connected to one terminal of the primary side of the transformer T, and the other terminal of the primary side of the transformer T is connected to the drain of the inverter-side MOSFET switching transistor Q3 of the right arm. A secondary-side dotted-terminal of a terminal of the transformer T connected to the primary-side equivalent inductor Lₗₖ is connected to the drain of the rectifier-side MOSFET switching transistor M1 and connected to the source of the rectifier-side MOSFET switching transistor M2, the anode of the antiparallel diode Dm1, the cathode of the antiparallel diode Dm2, one terminal of the stray capacitor Cm1 and one terminal of the stray capacitor Cm2. A secondary-side dotted-terminal of a terminal of the transformer T not connected to the primary-side equivalent inductor Lₗₖ is connected to the drain of the rectifier-side MOSFET switching transistor M3, and connected to the source of the rectifier-side MOSFET switching transistor M4, the anode of the antiparallel diode Dm3, the cathode of the antiparallel diode Dm4, one terminal of the stray capacitor Cm3 and one terminal of the stray capacitor Cm4. The cathode of the antiparallel diode Dm1 is connected to the cathode of the antiparallel diode Dm3, and connected to the anode of the output filter capacitor Cₒᵤₜ, the cathode of the output load R_{L}, the other terminal of the stray capacitor Cm1 and the other terminal of the stray capacitor Cm3. The anode of the antiparallel diode Dm2 is connected to the anode of the antiparallel diode Dm4, and connected to the cathode of the output filter capacitor Cₒᵤₜ, the cathode of the output load R_{L}, the other terminal of the stray capacitor Cm2 and the other terminal of the stray capacitor Cm4.

FIG. 2 is a schematic diagram of control of the switching transistors in the circuit according to the present invention, where V_{GS1} to V_{GS4} represent driving signals of the inverter-side MOSFET switching transistors Q1 to Q4, respectively, and V_{M1} to V_{M4} represent driving signals of the rectifier-side MOSFET switching transistors M1 to M4, respectively. In heavy-load cases, the operation of the phase-shift converter is the same as that of a conventional phase-shift converter. However, in light-load cases, as shown in FIG. 2, there are six stages in a positive half cycle.

In a stage of t₀<t<t₁, all the switching transistors M1 to M4 of the rectifier bridge have been turned off. On the inverter bridge side, the MOSFET switching transistor Q4 is turned on, and the MOSFET switching transistor Q2 is turned off at zero current since the primary-side current of the transformer T is zero. The main significance of this stage is to avoid the shoot-through short circuit between the MOSFET switching transistors Q1 and Q2. In a state of t₁<t<t₂, the MOSFET switching transistors Q1, M1 and M4 are turned on at zero current, the DC input voltage Vᵢₙ is applied to the primary side of the transformer T, and the secondary-side voltage of the transformer T is maintained at the output voltage Vₒᵤₜ by the output filer capacitor Cₒᵤₜ. This stage is called a “left-arm zero-current conversion stage”. In a state of t₂<t<t₃, the MOSFET switching transistors Q1 Q4, M1 and M4 are maintained in the ON state. This stage is a main power transfer stage. In a state of t₃<t<t₄, the MOSFET switching transistor Q1 is maintained in the ON state, the MOSFET switching, transistor Q4 is turned off, the energy stored in the equivalent inductor Lₗₖ starts to charge the stray capacitor C4 and meanwhile discharge the C3, and the antiparallel diode D3 is continuously turned on until the voltage of the stray capacitor C3 becomes zero. Hereafter, the MOSFET switching transistor Q3 is turned on at zero voltage, and the MOSFET switching transistors M1 and M4 are turned off at this stage. This stage is called a “right-arm zero-voltage conversion stage”. In a state of t₄<t<t₅, the MOSFET switching transistors Q1 and Q3 are continuously turned on, the primary-side voltage of the transformer T is zero, the energy stored in the equivalent inductor Lₗₖ is continuously transferred to the rectifier bridge side through the antiparallel diodes Dm1 and Dm4 and then transferred to the load, and the secondary-side voltage of the transformer T is continuously maintained at Vₒᵤₜ. This stage is called a “freewheeling stage”. In a state of t₅<t<t₆, the MOSFET switching transistors Q1 and Q3 are maintained in the ON state, the primary-side current of the transformer T is reduced to zero, and the antiparallel diodes Dm1 and Dm2 are biased reversely, so the network consisting of the output filter capacitor Cₒᵤₜ and the output load R_{L} is isolated from the rectifier bridge. As the output filter capacitor Cₒᵤₜ is large enough, the output voltage Vₒᵤₜ may remain almost unchanged.

As shown in FIG. 2, the working principle and mode in the negative half cycle in the light-load case is completely the same as that in the positive half cycle.

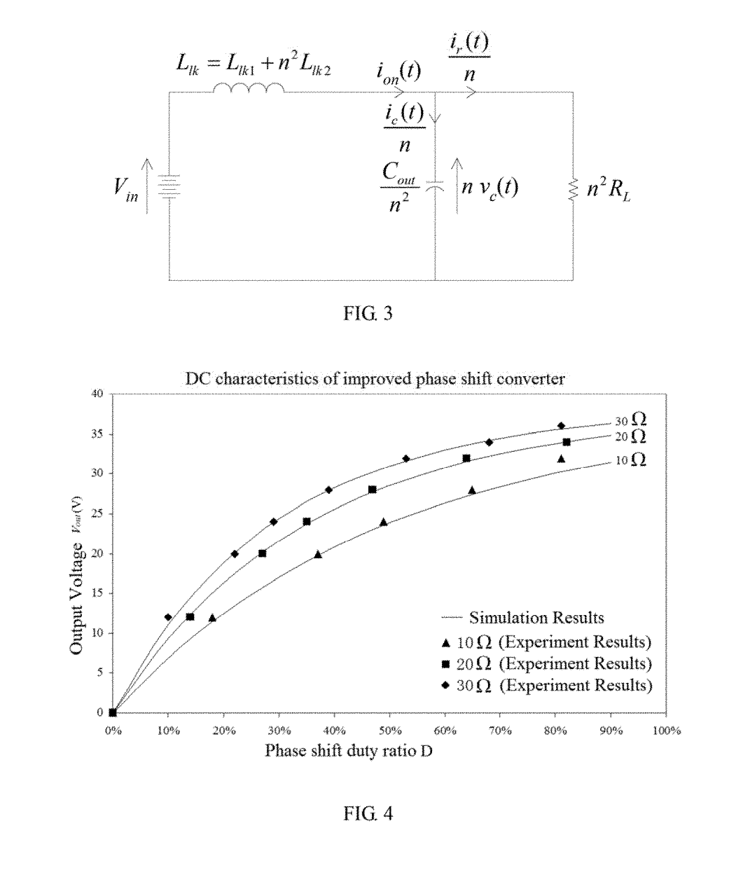

FIG. 3 is an equivalent circuit diagram of the power transfer stage according to the present invention. At this stage, energy is transferred from the output-side voltage to the load. iₒₙ(t) represents the primary-side current of the transformer at the power transfer stage, i_{off}(t) represents the primary-side current of the transformer at the freewheeling stage, v_{c}(t) represents the voltage of an equivalent output filter capacitor, i_{c}(t) represents the current of the equivalent output filter capacitor, and iᵣ(t) represents the current of an equivalent output load. The equivalent formulae of the circuits are as follows:

$$\begin{matrix}{L}_{lk} \frac{d}{dt} {i}_{on} ( t ) = {V}_{in} - n \cdot {v}_{c} ( t ) & ( 1 ) \\ {i}_{on} ( t ) = \frac{{i}_{r} ( t )}{n} + \frac{{i}_{c} ( t )}{n} & ( 2 ) \\ n \cdot {v}_{c} ( t ) = \frac{{i}_{r} ( t )}{n} \cdot {n}^{2} \cdot {R}_{L} & ( 3 ) \\ \frac{{i}_{c} ( t )}{n} = \frac{{C}_{out}}{{n}^{2}} \cdot \frac{d}{dt} [ n \cdot {v}_{c} ( t ) ] & ( 4 )\end{matrix}$$

The equations (1) to (4) are solved and then Laplace transform performed, so as to obtain the primary-side current iₒₙ(s):

$${I}_{on} ( s ) = \frac{\frac{s}{{L}_{lk}} + \frac{1}{{C}_{out} {L}_{lk} {R}_{L}}}{{s}^{2} + \frac{s}{{C}_{out} {L}_{lk}} + \frac{{n}^{2}}{{C}_{out} {L}_{lk} {R}_{L}}} \frac{{V}_{in}}{s} \frac{\frac{1}{{L}_{lk}}}{{s}^{2} + \frac{s}{{C}_{out} {L}_{lk}} + \frac{{n}^{2}}{{C}_{out} {L}_{lk} {R}_{L}}} {nV}_{out} \qquad ( 5 )$$

wherein s=jω, ω=2πƒ, and

$$f = \frac{1}{t} .$$

Therefore, inverse Laplace transform may be performed on equation (5) to obtain iₒₙ(t):

$${i}_{on} ( t ) = \frac{{V}_{in}}{{n}^{2} {R}_{L}} - \frac{{V}_{in}}{{n}^{2} {R}_{L}} {e}^{\frac{t}{2 {C}_{out} {R}_{L}}} cos ( θ \cdot t ) + ( \frac{2 {n}^{2} {C}_{out} {R}_{L}^{2} ( {V}_{in} - {nV}_{out} ) - {L}_{lk} {V}_{in}}{{n}^{2} {R}_{L} \sqrt{4 {n}^{2} {C}_{out} {L}_{lk} {R}_{L}^{2} - {L}_{lk}^{2}}} ) {e}^{\frac{t}{2 {C}_{out} {R}_{L}}} sin ( θ \cdot t ) \qquad ( 6 )$$

Wherein

$$θ = \frac{\sqrt{4 {n}^{2} {C}_{out} {L}_{lk} {R}_{L}^{2} - {L}_{lk}^{2}}}{2 {C}_{out} {L}_{lk} {R}_{L}} .$$

If it is assumed that the output filter capacitor Cₒᵤₜ is large enough and the leakage inductance Lₗₖ is small, the following in equations may be obtained:

4n²CₒᵤₜLₗₖR_{L}²>>Lₗₖ²

2n²CₒᵤₜR_{L}²Vᵢₙ >>LₗₖVᵢₙ

2CₒᵤₜR_{L}<<1.

Thus, the equation (6) may be simplified as follows (wherein ωₛ represents the switching angular frequency, ω₀ represents the output resonance frequency, and

$${ω}_{o} = \frac{n}{\sqrt{{L}_{lk} {C}_{out}}} ) \text{:}$$

$${i}_{on} ( t ) \approx \frac{{V}_{in} - {nV}_{out}}{{Z}_{o}} sin ( {ω}_{o} t ) .$$

At the end of this stage (t=DT/2, wherein D represents the phase-shift duty ratio and T represents the period), a peak value of the primary-side current is as follows:

$${I}_{peak} \approx D π \frac{{ω}_{o}}{{ω}_{s}} \frac{{V}_{in} - {nV}_{out}}{{Z}_{o}} \qquad ( 7 )$$

wherein Z₀ represents the characteristic impedance, and

$${Z}_{o} = n \sqrt{\frac{{L}_{lk}}{{C}_{out}}} .$$

If it is assumed that the input energy Wᵢₙ is equal to the output energy Wₒᵤₜ,

$${W}_{in} = \frac{1}{2} {V}_{in} {I}_{peak} D \frac{T}{2} , {W}_{out} = \frac{{V}_{out}^{2}}{{R}_{L}} \frac{T}{2} ,$$

then:

$${I}_{peak} = \frac{2 {V}_{out}^{2}}{{DR}_{L} {V}_{in}} \qquad ( 8 )$$

The equations (7) and (8) are solved to obtain the ratio of transformation of the voltage input and voltage output of the phase-shift converter (wherein ƒₛ represents the switching angular frequency, and

$${f}_{s} = \frac{{ω}_{s}}{2 π} ) \text{:}$$

$$\frac{{V}_{out}}{{V}_{in}} = \frac{1}{2} [ \sqrt{{( \frac{{nR}_{L} {D}^{2}}{4 {L}_{lk} {f}_{s}} )}^{2} + 4 ( \frac{{R}_{L} {D}^{2}}{4 {L}_{lk} {f}_{s}} )} - ( \frac{{nR}_{L} {D}^{2}}{4 {L}_{lk} {f}_{s}} ) ] \qquad ( 9 )$$

To check whether there is a linear relation between the output voltage and the phase-shift duty ratio D, a differential operation is performed on the equation (9) with respect to D:

$$\frac{d}{dD} ( \frac{{V}_{out}}{{V}_{in}} ) = \frac{{D}^{2} {n}^{2} {R}_{L} + 8 {L}_{lk} {f}_{s} - \sqrt{{D}^{2} {n}^{2} {R}_{L} ( 16 {L}_{lk} {f}_{s} + {D}^{2} {n}^{2} {R}_{L} )}}{\frac{4 {L}_{lk} {f}_{s}}{{DnR}_{L}} \sqrt{{D}^{2} {n}^{2} {R}_{L} ( 16 {L}_{lk} {f}_{s} + {D}^{2} {n}^{2} {R}_{L} )}} \qquad ( 10 )$$

As the denominator on the right side of the equation (10) is constantly greater than zero, it is only necessary to verify whether the value of the numerator is positive or negative. The value of the numerator is assigned to M:

M=D²n²R_{L}+8Lₗₖƒₛ−\sqrt{D²n²R_{L}(16LₗₖƒₛD²n²R_{L})} (11).

If M<0, then:

D²n²R_{L}+8Lₗₖƒₛ−\sqrt{D²n²R_{L}(16LₗₖƒₛD²n²R_{L})} [symbol] (8Lₗₖƒₛ)²>0.

As (8Lₗₖƒₛ)² is constantly greater than zero, both M and

$$\frac{d}{dD} ( \frac{{V}_{out}}{{V}_{in}} )$$

are constantly greater than zero when 0≦D≦1. Therefore, the output voltage of the converter always increases with the increase of the phase-shift duty ratio D.

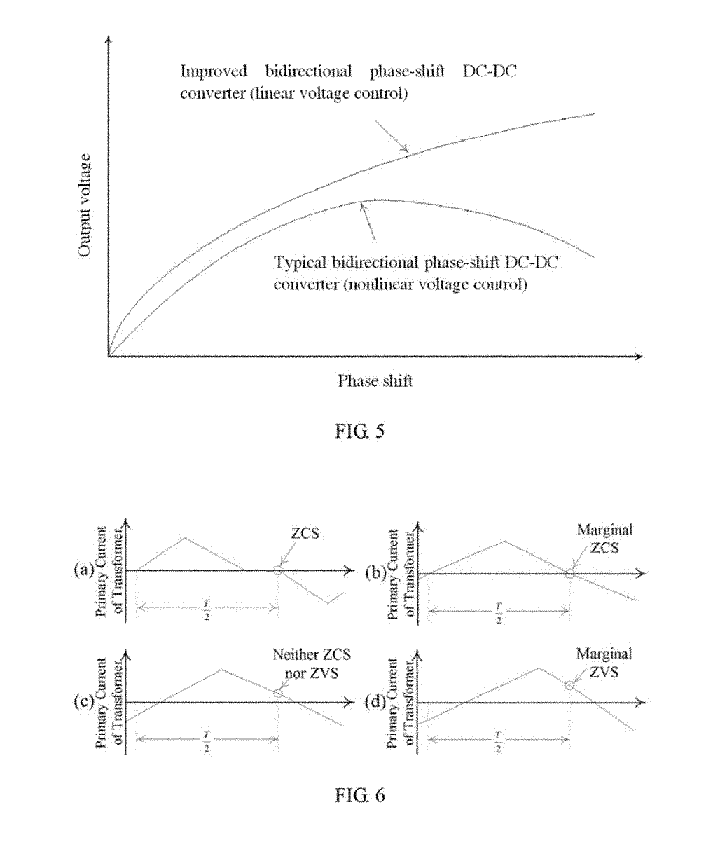

FIG. 4 is a schematic diagram of DC characteristics of an improved phase-shift converter according to the present invention, and FIG. 5 is a comparison diagram of an improved bidirectional phase-shift DC-DC converter (linear voltage control) and a typical directional phase-shift DC-DC converter (nonlinear voltage control) according to the present invention. The correctness of the mathematical calculations is verified by testing and simulating platforms.

FIG. 6 is a schematic diagram of the maximum load current under the boundary zero-current switching according to the present invention, showing four typical primary-side current cases. In (a) of FIG. 6, the converter drives a light load in a left-arm zero-current switching mode. When the load is gradually increased to a boundary value, as shown in (b) of FIG. 6, the zero-current switching may still be maintained. However, if the load exceeds the boundary value, the switching transistor whose left arm is in the ON state cannot operate in a zero-current switching mode, as shown in (c) of FIG. 6. Of course, if the load is high enough, the converter will operate in a normal heavy-load mode, as shown in (d) of FIG. 6.

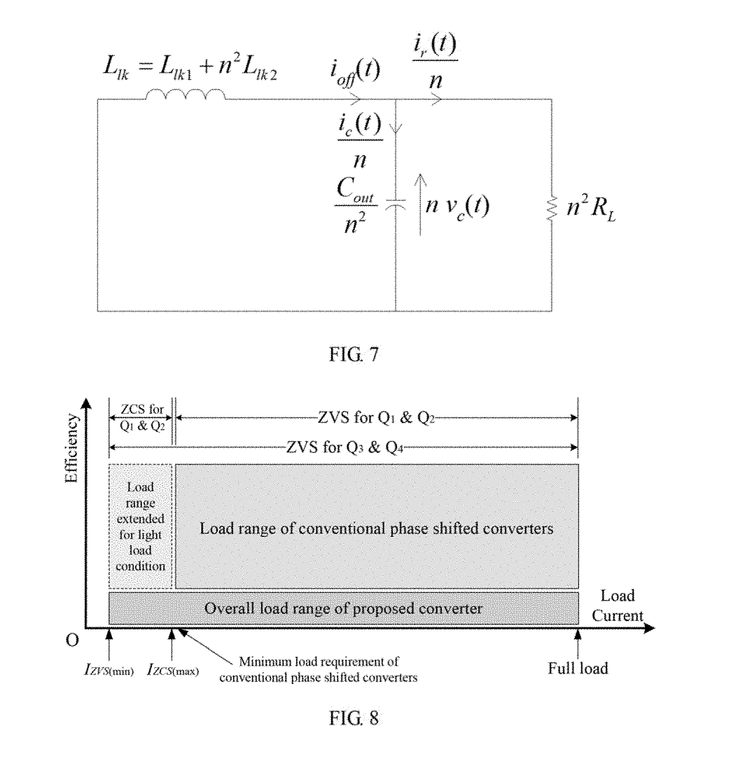

FIG. 7 is an equivalent circuit diagram of the freewheeling stage according to the present invention. Based on the circuit diagram, by mathematical calculations, the maximum load current that can be withstood by the left arm while realizing zero-current switching is:

$${I}_{ZCS ( max )} = \frac{{V}_{in} ( {n}^{2} {R}_{L} - 4 {L}_{lk} {f}_{s} )}{{n}^{3} {R}_{L}^{2}} \qquad ( 12 )$$

The minimum load current that can be withstood by the right arm while realizing zero-voltage switching is:

$${I}_{ZVS ( min )} = \frac{2 {V}_{in}}{{nR}_{L} {V}_{in} + \sqrt{{nR}_{L} {V}_{in} + \frac{4 {R}_{L}}{{C}_{sum} {f}_{s}} {( {V}_{in} - {nV}_{out} )}^{2}}} \qquad ( 13 )$$

wherein CₛᵤₘC₃+C₄C_{xƒmr}, C_{xƒmr} represents the equivalent capacitance of the transformer T.

FIG. 8 is a schematic diagram of an extended output load range according to the present invention, and also shows the boundary value of the load current in equations (12) and (13). The conventional phase-shift converter is merely applicable to the heavy-load mode. In contrast, by the zero-current and zero-voltage switching design of the left and right arms, the phase-shift converter of the present invention realizes the stable operation in the light-load case, so that the output load range, including light load and heavy load, of the phase-shift converter is extended.

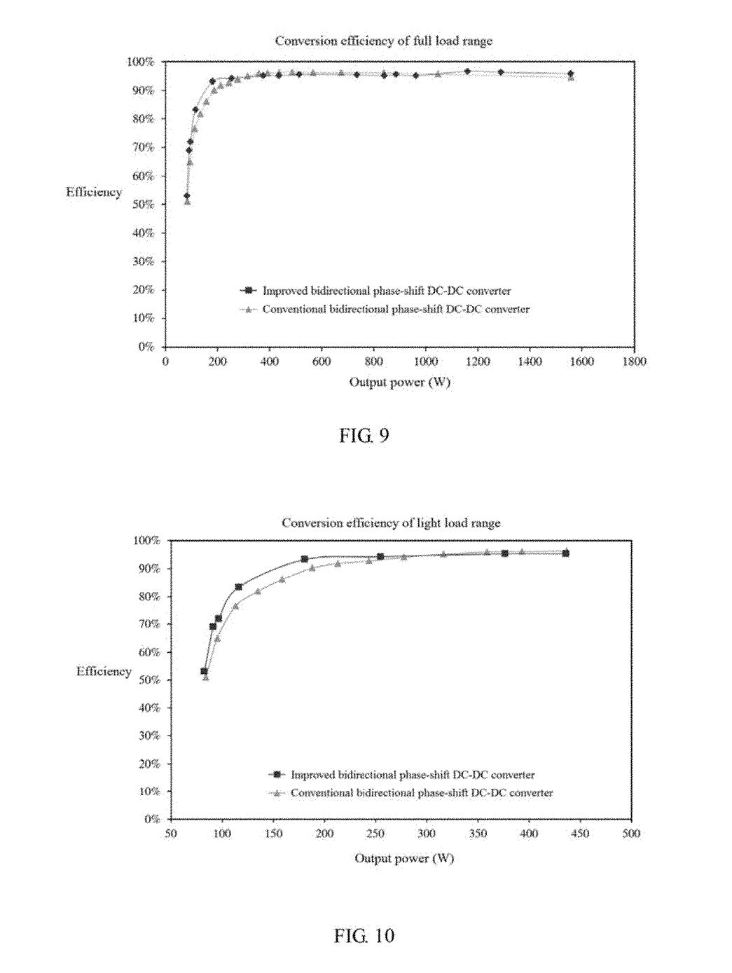

FIG. 9 is a comparison diagram of the power conversion efficiency of full load range according to the present invention, and FIG. 10 is a comparison diagram of the power conversion efficiency at light load case according to the present invention. The experimental data indicates that the conventional phase-shift transformer has low efficiency in light-load cases. As shown in FIG. 10, the efficiency at a load of 115 W is about 76.5% only. However, in the present invention, the efficiency of the improved converter at the output power of 115 W may reach 83.4%. The improvement of the efficiency is made, mainly because the zero-current switching of the inverter-side switching transistors greatly reduces the switching loss in the light-load case.

Experiments have proved that the improved phase-shift converter of the present invention may stably operate in the light-load case, and the output voltage linearly changes with the phase-shift duty ratio 0.

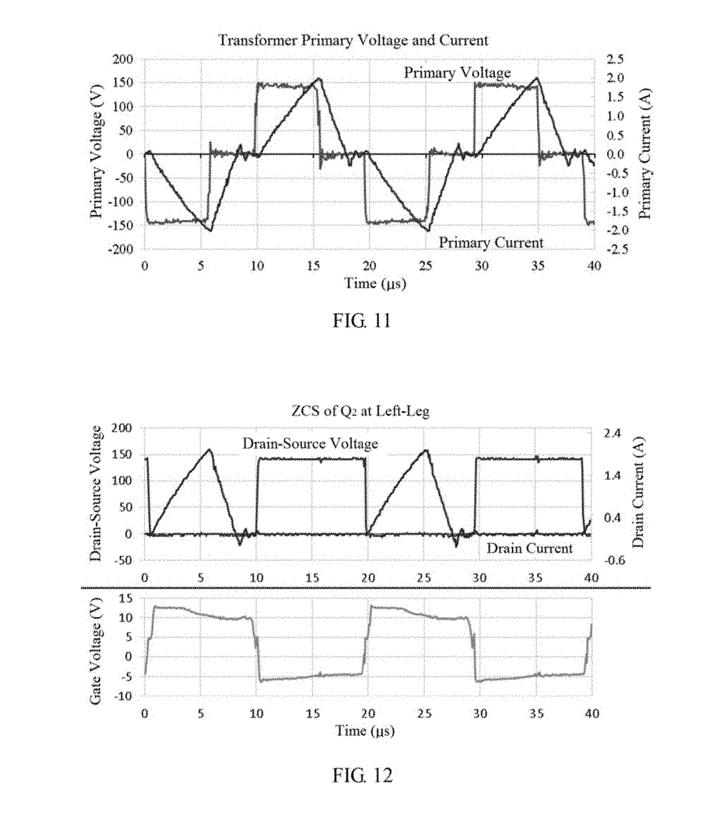

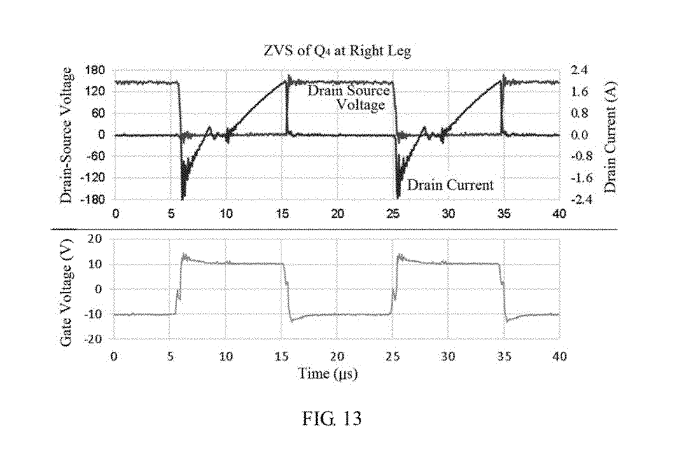

FIG. 11 is a diagram of transformer primary voltage and current of the present invention at output power of 115 W in the experiments. FIG. 12 is a diagram of drain-source voltage, drain current and gate voltage of transistor Q2 which shows its switching under zero current condition. FIG. 13 is a diagram of drain-source voltage, drain current and gate voltage of transistor Q4 which shows its switching under zero voltage condition. The primary current and voltage of transformer in FIG. 11 conform to the proposed theory very well, and the ZCS and ZVS are perfectly accomplished by Q2 at left-leg and Q4 at right-leg of inverter bridge as illustrated in FIG. 12 and FIG. 13 respectively, where Q2 switches on under zero current at t=0 μp, and Q4 switches on under zero voltage at t=6 μs when the drain-source voltage of MOSFET already reaches 0V.

The foregoing description merely shows preferred embodiments of the present invention and is not intended to limit the protection scope of the present invention.

What is claimed is:

1. A soft-switching bidirectional phase-shift converter with an extended load range, comprising: an inverter bridge, a rectifier bridge, a transformer connected between an output side of the inverter bridge and an input side of the rectifier bridge, and an equivalent inductor representing leakage inductance of a primary side of the transformer,
wherein a DC input voltage is applied to an input side of the inverter bridge, and an output load is connected to an output side of the rectifier bridge.

2. The soft-switching bidirectional phase-shift converter with an extended load range according to claim 1, wherein the inverter bridge comprises a leading bridge arm for realizing zero-current switching and a lagging bridge arm for realizing zero-voltage switching.

3. The soft-switching bidirectional phase-shift converter with an extended load range according to claim 2, wherein the leading bridge arm comprises: a first inverter-side MOSFET switching transistor Q1, and a first antiparallel diode D1 and a first stray capacitor C1 respectively corresponding to the first inverter-side MOSFET switching transistor Q1, the first inverter-side MOSFET switching transistor Q1, the first antiparallel diode D1 and the first stray capacitor C1 are all connected in parallel,
and a second inverter-side MOSFET switching transistor Q2, and a second antiparallel diode D2 and a second stray capacitor C2 respectively corresponding to the second inverter-side MOSFET switching transistor Q2, the second inverter-side MOSFET switching transistor Q2, the second antiparallel diode D2 and the second stray capacitor C2 are all connected in parallel;
and, the lagging bridge arm comprises a third inverter-side MOSFET switching transistor Q3 and a third antiparallel diode D3 and a third stray capacitor C3 respectively corresponding to the third inverter-side MOSFET switching transistor Q3, the third inverter-side MOSFET switching transistor Q3, the third antiparallel diode D3 and the third stray capacitor C3 are all connected in parallel,
and a fourth inverter-side MOSFET switching transistor Q4 and a fourth antiparallel diode D4 and a fourth stray capacitor C4 respectively corresponding to the fourth inverter-side MOSFET switching transistor Q4, the fourth inverter-side MOSFET switching transistor Q4, the fourth antiparallel diode D4 and the fourth stray capacitor C4 are all connected in parallel.

4. The soft-switching bidirectional phase-shift converter with an extended load range according to claim 3, wherein a drain of the first inverter-side MOSFET switching transistor Q1 is connected to an anode of the first antiparallel diode D1 and one terminal of the first stray capacitor C1, while a source of the first inverter-side MOSFET switching transistor Q1 is connected to a cathode of the first antiparallel diode D1 and the other terminal of the first stray capacitor C1;
a drain of the second inverter-side MOSFET switching transistor Q2 is connected to an anode of the second antiparallel diode D2 and one terminal of the second stray capacitor C2, while a source of the second inverter-side MOSFET switching transistor Q2 is connected to a cathode of the second antiparallel diode D2 and the other terminal of the second stray capacitor C2; the drain of the first inverter-side MOSFET switching transistor Q1 is connected to the source of the second inverter-side MOSFET switching transistor Q2; and
a drain of the third inverter-side MOSFET switching transistor Q3 is connected to an anode of the third antiparallel diode D3 and one terminal of the third stray capacitor C3, while a source of the third inverter-side MOSFET switching transistor Q3 is connected to a cathode of the third antiparallel diode D3 and the other terminal of the third stray capacitor C3;
a drain of the fourth inverter-side MOSFET switching transistor Q4 is connected to an anode of the fourth antiparallel diode D4 and one terminal of the fourth stray capacitor C4, while a source of the fourth inverter-side MOSFET switching transistor Q4 is connected to a cathode of the fourth antiparallel diode D4 and the other terminal of the fourth stray capacitor C4; and, the drain of the third inverter-side MOSFET switching transistor Q3 is connected to the source of the fourth inverter-side MOSFET switching transistor Q4.

5. The soft-switching bidirectional phase-shift converter with an extended load range according to claim 4, wherein an anode of the DC input voltage is connected to the source of the first inverter-side MOSFET switching transistor Q1 and the source of the third inverter-side MOSFET switching transistor Q3, while a cathode of the DC input voltage is connected to the drain of the second inverter-side MOSFET switching transistor Q2 and the drain of the fourth inverter-side MOSFET switching transistor Q4.

6. The soft-switching bidirectional phase-shift converter with an extended load range according to claim 2, wherein the inverter bridge further comprises an input filter capacitor which is located on the input side of the inverter bridge and connected to the DC input voltage in parallel; and, an anode of the DC input voltage is connected to an anode of the input filter capacitor, while a cathode of the DC input voltage is connected to a cathode of the input filter capacitor.

7. The soft-switching bidirectional phase-shift converter with an extended load range according to claim 4, wherein the rectifier bridge comprises: a first rectifier-side MOSFET switching transistor M1, and a fifth antiparallel diode Dm1 and a fifth stray capacitor Cm1 respectively corresponding to the first rectifier-side MOSFET switching transistor M1, the first rectifier-side MOSFET switching transistor M1, the fifth antiparallel diode Dm1 and the fifth stray capacitor Cm1 are all connected in parallel;
a second rectifier-side MOSFET switching transistor M2, and a sixth antiparallel diode Dm2 and a sixth stray capacitor Cm2 respectively corresponding to the second rectifier-side MOSFET switching transistor M2, the second rectifier-side MOSFET switching transistor M2, the sixth antiparallel diode Dm2 and the sixth stray capacitor Cm2 are all connected in parallel;
a third rectifier-side MOSFET switching transistor M3, and a seventh antiparallel diode Dm3 and a seventh stray capacitor Cm3 respectively corresponding to the third rectifier-side MOSFET switching transistor M3, the third rectifier-side MOSFET switching transistor M3, the seventh antiparallel diode Dm3 and the seventh stray capacitor Cm3 are all connected in parallel;
and a fourth rectifier-side MOSFET switching transistor M4, and a eighth antiparallel diode Dm4 and an eighth stray capacitor Cm4 respectively corresponding to the fourth rectifier-side MOSFET switching transistor M4, the fourth rectifier-side MOSFET switching transistor M4, the eighth antiparallel diode Dm4 and the eighth stray capacitor Cm4 are all connected in parallel.

8. The soft-switching bidirectional phase-shift converter with an extended load range according to claim 7, wherein one terminal of the equivalent inductor is connected to the drain of the first inverter-side MOSFET switching transistor Q1 of the leading bridge arm while the other terminal of the equivalent inductor is connected to one terminal of the primary side of the transformer, and the other terminal of the primary side of the transformer is connected to the drain of the third inverter-side MOSFET switching transistor Q3 of the lagging bridge arm; a secondary-side dotted-terminal of a terminal of the transformer connected to a primary-side equivalent inductor is connected to a drain of the first rectifier-side MOSFET switching transistor M1, and connected to a source of the second rectifier-side MOSFET switching transistor M2, an anode of the fifth antiparallel diode Dm1, a cathode of the sixth antiparallel diode Dm2, one terminal of the fifth stray capacitor Cm1 and one terminal of the sixth stray capacitor Cm2;
a secondary-side dotted-terminal of a terminal of the transformer not connected to the primary-side equivalent inductor is connected to a drain of the third rectifier-side MOSFET switching transistor M3, and connected to a source of the fourth rectifier-side MOSFET switching transistor M4, an anode of the seventh antiparallel diode Dm3, a cathode of the eighth antiparallel diode Dm4, one terminal of the seventh stray capacitor Cm3 and one terminal of the eighth stray capacitor Cm4; a cathode of the fifth antiparallel diode Dm1 is connected to a cathode of the seventh antiparallel diode Dm3, and connected to a cathode of the output load, the other terminal of the fifth stray capacitor Cm1 and the other terminal of the seventh stray capacitor Cm3; and, an anode of the sixth antiparallel diode Dm2 is connected to an anode of the eighth antiparallel diode Dm4, and connected to the cathode of the output load, the other terminal of the sixth stray capacitor Cm2 and the other terminal of the eighth stray capacitor Cm4.

9. The soft-switching bidirectional phase-shift converter with an extended load range according to claim 8, wherein the rectifier bridge further comprises an output filter capacitor located on the output side; the cathode of the fifth antiparallel diode Dm1 and the cathode of the seventh antiparallel diode Dm3 are connected to an anode of the output filter capacitor, and the anode of the output filter capacitor is connected to an anode of the output load; and, the anode of the sixth antiparallel diode Dm2 and the anode of the eighth antiparallel diode Dm4 are connected to a cathode of the output filter capacitor, and the cathode of the output filter capacitor is connected to the cathode of the output load.

10. The soft-switching bidirectional phase-shift converter with an extended load range according to claim 1, wherein, in a specially designed switching transistor control mode, the soft-switching bidirectional phase-shift converter is applicable to light-load cases, without influencing an operation in heavy-load cases, so that a linear control of an output voltage of the soft-switching bidirectional phase-shift converter is realized.
